(19) United States
(12) Patent Application Publication
(10) Pub. No.: US 2006/0168744 A1
(43) Pub. Date: Aug. 3, 2006

(54) Electric toothbrush for implementing the bass brushing technique

(76) Inventors: Clarence P. Butler, Grayson, GA (US); Stephen A. Nevue, Huntsville, AL (US); Ngar Ling Cheng, Sheung Shui (CN)

Correspondence Address: LAURENCE P. COLTON, 1201 WEST PEACHTREE STREET, NW, 14TH FLOOR, ATLANTA, GA, 30309-3488, US

(21) Appl. No.: 11/046,393

(22) Filed: Jan. 28, 2005

(51) Int. Cl. A61C 17/22

(52) U.S. Cl. 15/22.1

(57) ABSTRACT

An electric toothbrush for brushing teeth and gums having a generally cylindrical handle having a longitudinal axis and a generally hollow interior, a stem attached to the handle, a head connected to the stem and having a front portion with a plurality of tufts of bristles anchored to the head, and a motor housed in the hollow interior of the handle, wherein the stem is operatively moved by the motor such that the stem pivots with respect to the longitudinal axis of the cylindrical handle by a predefined angle Θ within a plane generally normal to the plurality of tufts of bristles to impart a measured up and down sweeping motion to the head relative to the teeth and gums being brushed.

### BACKGROUND OF THE INVENTION

1. Technical Field

This invention relates to an electric toothbrush in which the head and neck of the toothbrush, when activated, move in a sweeping motion in a lateral plane relative to the handle to impart a measured and recommended up and down motion to the toothbrush head and neck relative to the teeth. This invention further relates to an electric toothbrush with interchangeable, bendable heads that may be shaped and/or rotated about the axis of the handle so that the head of the toothbrush is positioned at an optimum angle relative to the surface of the teeth and gums.

2. Prior Art

More than 70% of adults over the age of thirty eventually face some form of gum disease. In correct brushing habits play a major role in developing gum disease, particularly by not reaching all areas of the mouth consistently and by not brushing at a 45° angle to the gum line as recommended by the American Dental Association (ADA).

The Bass technique of brushing teeth is widely recommended by the ADA for removal of plaque that accumulates on the surface of the teeth and in the sulcus, i.e., the tooth surface that is hidden by the gums. Basically, this technique involves two things: (1) orienting the bristles of a toothbrush at about a 45° angle relative to the surface of the teeth, and (2) moving the toothbrush up and down with short strokes. Thus, when a person uses this technique, a portion of the bristles clean the teeth while another portion of the bristles clean the gums. Implementation of this technique with a standard toothbrush requires the user to rotate his or her wrist at about a 45° angle while at the same time using the short up and down strokes on both the front and back surfaces of the teeth, both the top and bottom sets. Holding one's wrist in this unnatural position and moving the brush with the recommended strokes, while brushing for the time period recommended by dental professionals, can be quite tiring, particularly for children and individuals with arthritis. Often these individuals do not have the necessary manual dexterity or stamina to effectively practice the Bass brushing technique.

One of the inventors of the present invention has two US patents covering manual toothbrushes for implementing the Bass technique so as to help in properly implementing the Bass brushing technique. U.S. Pat. No. 5,749,381 discloses an ergonomically designed manual toothbrush having an oversized handle and a shapeable stem. The handle is generally cylindrical in shape so as to readily fit in the palm of one's hand while having a flattened portion against which the thumb and fingertips may be rested. The stem is attached to the handle in such a manner as to allow rotation of the stem in a variety of positions about the longitudinal axis of the handle. The user of the toothbrush may set the orientation of the bristles on the heads such that they are at a 45° inclination relative to the surface of the teeth while the flat portion of the handle is generally parallel to the surface of the teeth so that the Bass technique may be implemented white moving the toothbrush up and down in short strokes in a conventional manner. U.S. Pat. No. 5,850,659 is a continuation in part of U.S. Pat. No. 5,749,381 and discloses an ergonomically designed manual toothbrush having an oversized handle and a shapeable stem. However, this toothbrush also discloses flexible heads that the user may bend so that all teeth may be effectively reached and brushed regardless of the contour of one's teeth and mouth.

The prior art toothbrushes specifically designed for implementing the Bass brushing technique are manual toothbrushes. Therefore, a need exists for an electric toothbrush that facilitates use of the Bass brushing technique while not imposing unnecessary burdens on the user of the toothbrush, such as hand and wrist fatigue, which discourage proper brushing technique. Further, many in the dental field believe that electric toothbrushes clean the teeth and gums better in that the bristles are moved at a faster rate. Thus, there is a need for an electric toothbrush that allows one to easily implement the Bass brushing technique. The present invention is such a toothbrush.

### BRIEF SUMMARY OF THE INVENTION

The present invention is an electric toothbrush for easily implementing the Bass brushing technique. The toothbrush comprises a generally cylindrical handle body and a stem having a head with bristles. The handle body comprises a handle, an interior compartment for containing the motion imparting system (the motor, battery and transmission components), a drive means for imparting a sweeping up and down motion to the stem for brushing the teeth, and a rotation means for allowing the rotation of the interchangeable stem. The stem comprises a toothbrush head with bristles and a neck for attachment to the handle body. The handle is oversized and generally cylindrical with a front flat surface to enhance manual dexterity and to make gripping more comfortable for the user.

The stem is designed such that it can be rotated in relation to the handle. The stems may be in a variety of head and bristle configurations. The rotation means is adapted so that the stem may be selectively positioned at one of a plurality of locations about the longitudinal axis of the handle, preferably at exactly a ±45° angle relative to the front flat surface of the handle. With such an arrangement, the Bass brushing technique may be implemented by utilizing the rotation means to adjust the orientation of the bristles such that they are aligned at a ±45° angle relative to the surface of the teeth while the handle is held in a comfortable grip, generally parallel to the surface of the teeth.

When the toothbrush is activated, the motor rotates an offset drive pin causing the stem to move such that the head is moved up and down (relative to the surface of the teeth and gums) in a lateral plane relative to the handle to impart a measured and ADA recommended up and down sweeping motion to the head and neck relative to the teeth. This brushing stroke brushes the teeth and gums exactly as recommended by the ADA. All the user needs to do is set the ±45° angle for the stem, turn the toothbrush on, apply the toothbrush to the teeth, and slide the toothbrush laterally on the teeth. The electric motor and gearing design imparts the recommended up and down sweeping motion to the toothbrush head to brush the teeth up and down while the user slides the toothbrush over all surface areas of the teeth. Thus, after the head with the bristles is rotated to a ±45° angle to left or to the right to allow easy implementation of the Bass brushing technique, the motor is activated causing the head to move upwards and downwards relative to the teeth and the user moves the toothbrush in a lateral manner, effectively cleaning the teeth along a plurality of axes. The sweeping motion provides a recommended up and down brushing of the teeth and also gets under the gums. In effect, the present invention brushes the teeth for the user with a minimal amount of hand and arm motion, which is advantageous for the very young, the elderly, the infirm, and the lazy.

The generally cylindrical portions of the handle permit the user of the toothbrush to brush all dental surfaces while maintaining the same comfortable grip on the handle and simply adjusting the rotational angle of the head. In addition, the stem and head are shapeable so that they may be repositioned to obtain the most effective shape, alignment and brushing angles for the particular user of the toothbrush.

The toothbrush optionally may comprise interchangeable stems and an attachment means for allowing the attachment of the interchangeable stems. In this embodiment, the interchangeable stem comprises a toothbrush head with bristles and a neck for attachment via the attachment means to the handle body. The interchangeable stems may be in a variety of head and bristle configurations, such as hard bristles or soft bristles, and various shaped heads, for interchangeable use by the same person for different teeth brushing needs, or for different persons using the same handle. In this embodiment, the rotation means utilized to allow the rotation of the stems may be a component of the stem or the handle, although it is preferred to be a part of the handle in order to reduce the manufacturing costs of the stems so that they may be marketed relatively inexpensively and independently of the handle.

These features, and other features and advantages of the present invention, will become more apparent to those of ordinary skill in the relevant art when the following detailed description of the preferred embodiments is read in conjunction with the appended drawings in which like reference numerals represent like components throughout the several views.

### BRIEF DESCRIPTION OF THE DRAWINGS

FIG. 1A is a front view of the toothbrush of the present invention demonstrating a standard head orientation.

FIG. 1B is a front view of the toothbrush of FIG. 1A showing the stem and head rotated +45 degrees from the position depicted in FIG. 1A.

FIG. 1C is a front view of the toothbrush of FIG. 1A showing the stem and head rotated −45 degrees from the position depicted in FIG. 1A and 90 degrees from the toothbrush depicted in FIG. 1B.

FIG. 2A is a sectional front view of an internal motorized movement mechanism of an embodiment of a toothbrush according to the present invention showing the interconnection means between the handle and the stem.

FIG. 2B is a sectional front view of an internal motorized movement mechanism of an embodiment of a toothbrush according to the present invention showing a preferred movement of the stem and head.

FIG. 2C is a sectional side view of the internal motorized movement mechanism of FIG. 2B and the stem.

FIG. 3A is an enlarged portion of the motorized movement mechanism as shown in FIGS. 2A-2B.

FIG. 3B is an enlarged portion of the motorized movement mechanism as shown in FIG. 2C.

FIG. 3C are top view schematics of the motion of a drive pin and stem suitable for use in the present invention.

FIG. 4 is a side view of the toothbrush of FIG. 1A demonstrating various static positions in which the stem may be placed.

FIGS. 5A-5D are front views of preferred stems for the toothbrush.

FIG. 5E is a partial section view along section line A from FIG. 5A.

FIG. 6A is a front view of a preferred embodiment of the bendable toothbrush head of the present invention.

FIGS. 6B-6D are side views of the bendable toothbrush head depicted in FIG. 6A.

### DETAILED DESCRIPTION OF THE PREFERRED EMBODIMENTS

The present invention is an electric toothbrush for implementing the method of brushing teeth that is recommended by the ADA, that is, the Bass brushing technique. This technique has been shown to be most effective in removing plaque and food particles from the inner, outer, and biting surfaces of teeth as well as the gingival margin. The technique involves holding a toothbrush such that the bristles are oriented at approximately a forty-five degree (45°) angle relative to the surface of the teeth with about half the bristles touching the teeth and the other half touching the gums while gently moving the toothbrush in short (half-a-tooth-wide) strokes.

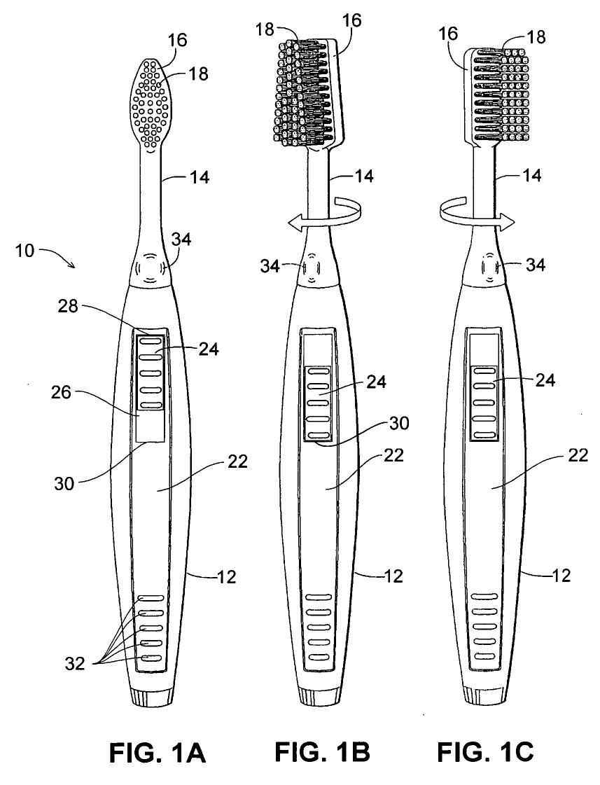

FIG. 1A is a front view of an electric toothbrush according to the present invention showing a sliding switch embodiment for activating the internal motorized movement mechanism. FIG. 1B is a front view of an electric toothbrush according to the present invention in which the stem has been pivoted +45° with respect to the handle. FIG. 1C is a front view of an electric toothbrush according to the present invention in which the stem has been pivoted −45° with respect to the handle.

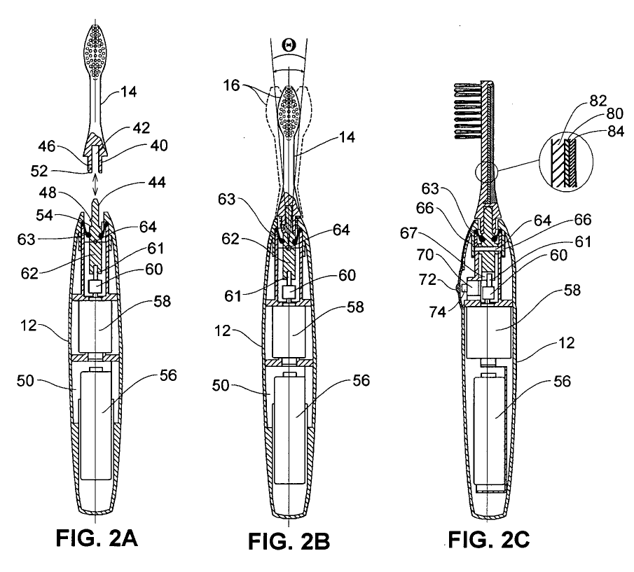

FIG. 2A is a partial sectional front view of a toothbrush according to the present invention showing the interconnection between the stem and the handle body and the placement of the motor, battery, and drive train within the hollow interior of the handle body. FIG. 2B is a partial sectional front view of the toothbrush according to FIG. 2A showing how the stem moves. FIG. 2C is a partial sectional side view of the toothbrush of FIG. 2B showing a press switch embodiment for activating the internal motorized movement mechanism.

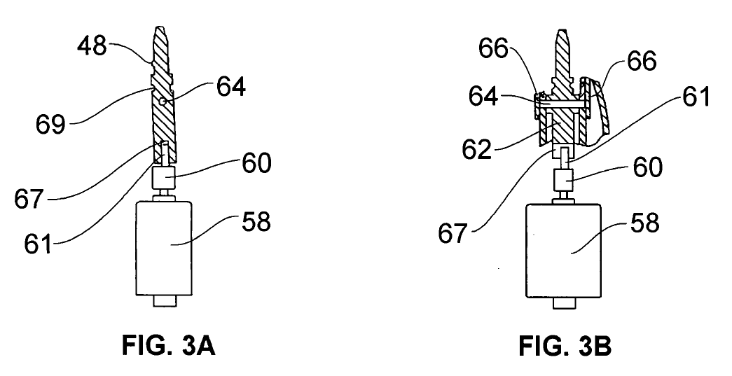

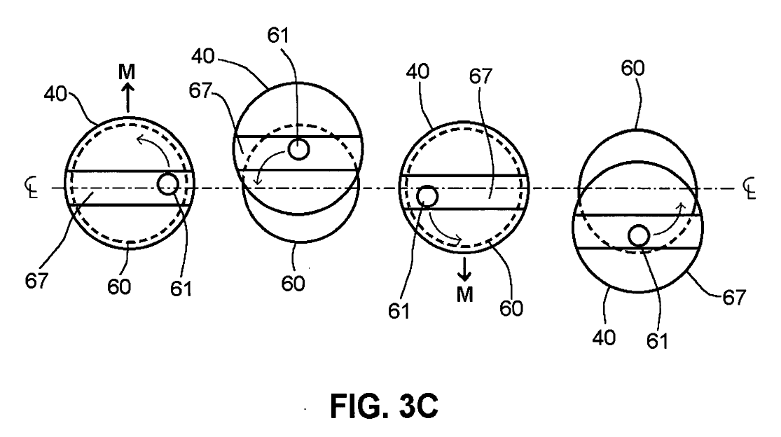

FIG. 3A is an enlarged partial sectional view of a mechanism for moving the stem as shown in FIG. 2B. FIG. 3B is a side view of the mechanism of FIG. 3A. FIG. 3C are top view schematics of the motion of a drive pin 61 and stem 14 suitable for use in the present invention illustrating the drive mechanism for imparting the sweeping motion for the stem 14 and head 16.

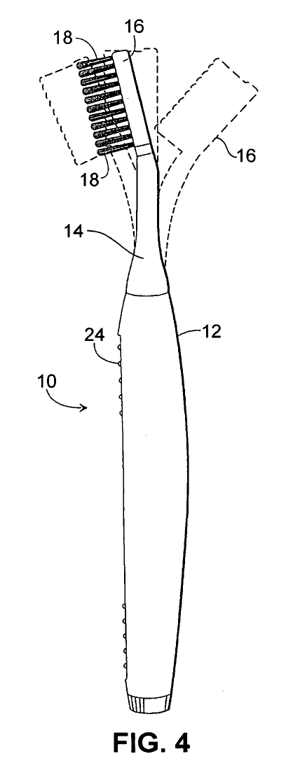

FIG. 4 is a side view of toothbrush 10 demonstrating various static positions in which stem 14 may be placed. Both stem 14 and head 16 are bendable so as to be able to customize their shapes to the shape of the mouth and dental structure of the user.

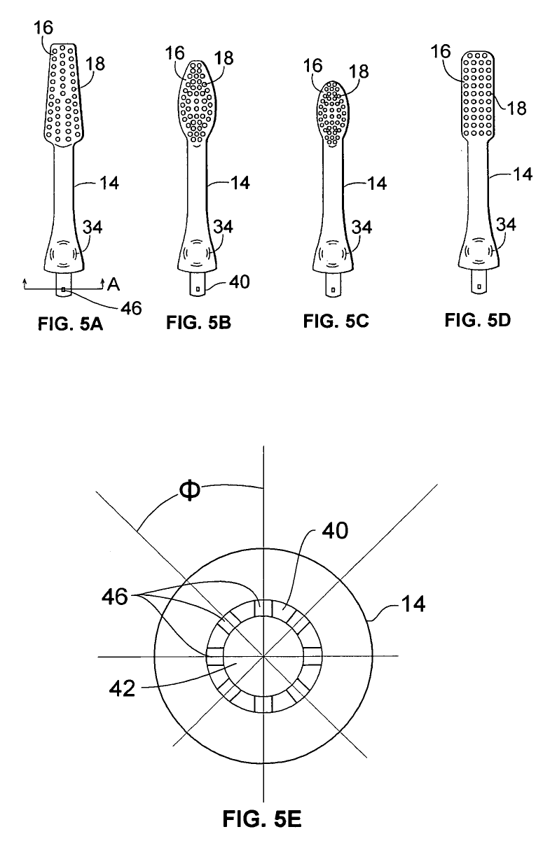

FIGS. 5A-5D are front views of preferred attachments for toothbrush 10, and an attachment means for the optional detachable stems 14. FIG. 5E is a partial sectional view along section line A of FIG. 5A illustrating an embodiment of the ±45° rotation mechanism. For example, these illustrations show different head 16 designs; however, the attachments can have different bristle designs or configurations, different bristle hardnesses, and/or be different dental tools.

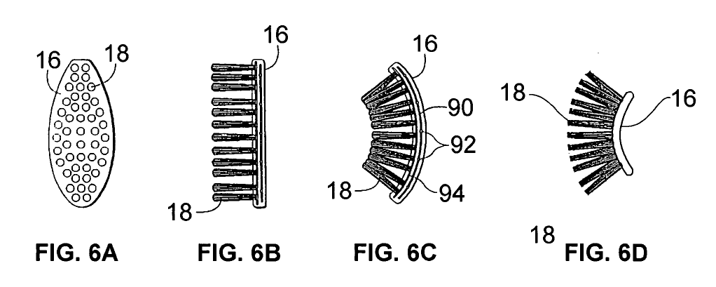

FIG. 6A is a front view of a preferred embodiment of the bendable toothbrush head 16 of the present invention. FIGS. 6B-6C are side views of the bendable toothbrush head depicted in FIG. 6A.

FIGS. 1A-1C show a preferred embodiment of the toothbrush 10 of the present invention. Toothbrush 10 includes a handle body 12 (also referred to as just the handle), which has a larger diameter than the standard, commercially available toothbrush, which makes handle 12 more comfortable and easier to use because less force is required to stably hold toothbrush 10. Also, when handle 12 is larger, toothbrush 10 requires less rotational turning about its longitudinal axis than is required by a smaller handle to achieve the same result. Handle 12 is preferably generally cylindrical in shape having a cross section which is predominantly circular (about one inch in diameter) except for a generally flat portion 22 defined by a chord of the circular cross section of handle 12 which surface may also include an activator slide 24 or press button 72 (see FIG. 2C) to turn toothbrush 10 on/off. It is preferred that activator slide 24 slide within a channel 26, such that when activator slide 24 is in a first position, i.e. when activator slide 24 is at a first end 28 of channel 26, toothbrush 10 is “on” (power is provided to the motor causing movement of the stem 14 and head 16), whereas when activator slide 24 is at a second position 30, toothbrush 10 is “off” (power is not provided to the motor causing movement of the stem 14 and head 16). It is, of course, within the scope of the invention to use alternate means of switching toothbrush 10 from on to off, such as the press button 72 mentioned.

Generally flat portion 22 preferably can extend along almost the entire length of handle 12 and provides a convenient surface against which one's thumb and fingertips may be placed while brushing. Handle 12 preferably is formed of or comprises a “squeezable” or compressible material that deflects slightly when a gripping force is applied. Such a construction makes toothbrush 10 more comfortable to hold and therefore easier to use. Optionally, toothbrush 10 may be formed in a double-sided configuration with a flat portion 22 and grips 32 on both the front and back (not shown) of handle 12 to aid in more firmly grasping handle 12, particularly when handle 12 is wet. In the double-sided configuration one is enabled to implement the Bass brushing technique in all quadrants of the mouth while maintaining the same grip on handle 12. Further preferred enhancements include grips 32 that are preferably arranged either vertically or horizontally as depicted in FIGS. 1A-1C to present an aesthetically pleasing appearance, although any number and shape of grips 32 may be included. The provision of multiple raised sections or grips 32 on both the front and back of handle 12 permit the user of toothbrush 10 to brush all dental surfaces while maintaining the same grip on handle 12 by simply adjusting the rotational angle of head 16.

Stem 14 can be designed to be pivotable up to 360 degrees in either a clockwise or counterclockwise direction so that in at least one position head 16 may be angled relative to handle 12. In the preferred embodiment, head 16 may be rotated 45° to one side relative to flat portion 22 (relatively flat portion 22 is considered the front of toothbrush 10) and 45° to the other side of flat portion 22, namely ±45° relative to flat portion 22, or relative to the front of toothbrush 10 if there is no relatively flat portion 22. However, it will be clear to those skilled in the art that other angular increments may be utilized while still permitting implementation of the Bass brushing technique or a modified Bass brushing technique. For example, 1, 5, 15, or 22.5 degree increments may be used. With such an arrangement, toothbrush head 16 can easily be used to carry out the Bass brushing technique by pivotable head 16 so that bristles 18 are at about a 45° angle relative to the surface of the teeth. FIGS. 1B and 1C show toothbrush 10 with stem 14 pivoted about handle 12 by approximately ±45°, respectively, relative to toothbrush 10 in FIG. 1A in order to implement the Bass technique. Such configurations enable the user to brush all surfaces of all quadrants of the user's mouth using the same grip on the toothbrush.

It is preferred that some surface treatment or other aid be included with or on stem 14 to aid in pivoting the stem with respect to handle 12. One preferred mechanism is shown in FIGS. 1A-C in which one or more protrusions or indentations, such as circular indentations 34, are provided at the base of stem 14 to assist in gripping stem 14 when it is being connected to handle 12 and when it is being pivoted. Alternatively, stem 14 can easily be rotated by holding head 16 and/or stem 14 between the teeth and simply rotating handle 12 to the desired angle or position.

FIG. 2A illustrates a preferred means of attaching stem 14 to handle 12 to form toothbrush 10 for both the non-detachable and the detachable embodiments of the invention. Shown is pivotable stem 14, which preferably includes a cylindrical extension 40 with an internal cylindrical channel 42 that fits over a post 44 of handle 12. In order to retain stem 14 on post 44 and in one of several predefined orientations, cylindrical extension 40 includes several holes or indentations 46 which allow a protrusion or catch 48 on post 44 to extend into the hole 46 when stem 14 is properly seated on handle 12. In particular, as stem 14 is slid over post 44, hole 46 may be aligned with a respective protrusion 48 such that the stem is maintained on post 44 in a selected orientation. In the alternative detachable embodiment, stem 14 can be pulled off of post 44, in which case, hole 46 will disengage from catch 48. It is further permissible to use any other means of removably attaching stem 14 to handle 12 as is known in the art.

To change the orientation of stem 14 with respect to handle 12, that is to move stem 14 in a ±45° angle relative to flat portion 22, stem 14 or handle 12 is simply pivoted with respect to the other member such that a second protrusion goes into the same hole 46, or the same original protrusion is mated with a second hole. Though it is preferred to have multiple holes 46 and a single protrusion 48, it is of course within the scope of the invention to have any number of holes 46 or protrusions 48 as long as there are at least two different orientations (that is, at least ±45°) between stem 14 and handle 12. At the lower end of cylindrical extension 40 is a lower surface 52 which preferably meets with a corresponding upper surface 54 on stem 14 to provide a solid connection between handle 12 and stem 14 and as a stop to prevent stem 14 from being inserted too far onto post 44. It is preferred that cylindrical channel 42 completely surround and be closely fitted with post 44 and that lower surface 52 and upper surface 54 mate in order to minimize hysteresis in toothbrush 10.

FIGS. 2A-2C illustrate that handle 12 includes a hollow portion 50 that houses a drive mechanism including a battery 56 and a motor 58 that the battery 56 powers. Toothbrush 10 drive mechanism further includes a drive wheel 60, which is operatively connected to and powered by motor 58 on a first side, and drive pin 61, which is attached to in an offset manner to wheel 60 on a second side opposite the first side. Post 44, on the end opposite where stem 14 connects to post 44, comprises a drive rod 62, which is operatively connected to drive pin 61 via linear slot 67 formed in the bottom of drive rod 62. A pivot pin 64 extends horizontally through (that is, normal to the axis of) drive rod 62 and pivotally supports drive rod 62/post 44 within the interior of handle 12. Alternatively, pivot pin 64 can be horizontal extensions of drive rod 62. In the preferred embodiment, pivot pin 64 is a rod extending between facing internal walls of bracket 66 and through a horizontal channel through drive rod 62, thus in effect partially suspending drive rod 62 in a pivoting manner within the interior of handle 12.

Activation of motor 58 causes wheel 60 to spin, which causes drive pin 61 to trace a circular path in, for example purposes, a horizontal X-Y plane. Linear slot 67 is collinear with the axis of pivot pin 64. Thus, as drive pin 61 moves in the X-axis direction component (which for this illustration is the direction of linear slot 67 and the axis of pivot pin 64) by wheel 60, drive pin 61 slides within linear slot 67 imparting no X-axis direction motion to drive rod 62. However, as drive pin 61 moves in the Y-axis direction component (which for this illustration is normal to the direction of linear slot 67 and the axis of pivot pin 64) by wheel 60, drive pin 61 contacts the side walls of linear slot 67 and causes drive rod 62 to pivot about pivot pin 64 causing drive rod 62 to pivot about pivot pin 64 such that stem 14 also moves, pivoting about pivot pin 64 in a side-to-side motion in a plane normal to the axis of pivot pin 64 (that is, in a Z-axis direction plane extending normal from the Y-direction plane along the Y-axis). This is the motion that imparts a planar (two-dimensional) sweeping motion to stem 14 and head 16.

It is preferred that toothbrush 10 be configured such that the end of head 16 distal from handle 12 sweeps in angle Θ by up to about 10 degrees, with a more preferred range of about 2-6 degrees. It has been found that this angle range combined with the common combined length of stem 14 and head 16 results in a sweeping movement of head 16 a distance satisfactory for brushing the teeth without having to move toothbrush 10 itself up and down relative to the teeth. Though it is most preferred that stem 14 move/pivot/sweep in one plane as shown in FIG. 2B such that the bristles do not move appreciably toward/away from handle 12, it is also within the scope of the invention that stem 14 also move slightly toward and/or away (that is, in a pumping or in-and-out direction in the Z-axis direction relative to handle 12) from handle 12 such that head 16 moves toward and/or away from handle 12 (it is preferred that if head 16 moves in this additional lateral direction that this movement is approximately ½ the width of a human tooth, i.e., approximately 1/16 to ⅛ inch, in accordance with the Bass brushing technique).

Gasket 63 attaches to both handle 12 and stem 14 and can fit within depression 69 on stem 14. Gasket 63 serves at least two purposes. First, gasket 63 provides a seal preventing water, toothpaste, saliva and/or other debris from entering the interior of handle 12. Second, gasket 63 provides additional lateral support for stem 14 and drive rod 62. Preferably, gasket is made from a flexible material such as latex or other natural rubbers, synthetic rubbers, hypo- or non-allergic flexible materials such as silicon, Nylon® or vinyl, or other suitable materials.

FIG. 2C illustrates means to turn the toothbrush 10 on and off. For example, switch 70 is provided to control operation of the electric toothbrush 10 and is operatively connected to motor 58. Switch 70 preferably includes a molded actuator button 72 and a switching means 74. Switch 70 may be manually depressed by pressing molded actuator button 72 down, which then presses against switching means 74, completing the electrical circuit between battery 56 and motor 58 and providing operation of the toothbrush. Alternatively, as shown in FIG. 1A-1C, activator slide 24 may operate to turn toothbrush 10 on/off as is known in the art. Common switches known in the art can be used or adapted for use with the toothbrush 10. It is preferred that switch 70 is of a waterproof or water-resistant type. It should be noted that other sizes and shapes of buttons may be used including more complicated devices that permit continuous operation as known in the art.

FIG. 2C and FIG. 4 illustrate that stem 14 preferably is shapeable so that stem 14 and head 16 can be positioned at any fixed position necessary or desired to reach areas of the mouth that are otherwise difficult to reach with a standard toothbrush. To achieve this purpose, stem 14 may be provided with a centrally located wire 80 of a size and stiffness sufficient to maintain head 16 and stem 14 in a configuration selected by the user of toothbrush 10 while at the same time withstanding the forces applied to head 16 and stem 14 during brushing. Though it is preferred to have centrally located wire 80 in stem 14 between the bristle side 82 and the back side 84, it is also within the scope of the invention to locate the wire in other locations, or to form stem 14 itself from a material that will permit and retain shape changes. In this manner, head 16 and stem 14, individually or together, can be bent into a suitable or desired shape or curve to effectuate more efficient brushing.

FIGS. 3A and 3B are enlarged illustrations of the motion imparting means shown in FIGS. 2A-2C to assist in illustrating the drive mechanism for achieving the sweeping motion imparted to the stem 14 and head 16. FIG. 3A illustrates a front view of the drive mechanism as shown in FIG. 2B, and FIG. 3B illustrates a side view of the drive mechanism as shown in FIG. 2C. FIG. 3A illustrates that drive pin 67 is mounted in an offset manner on wheel 60, that is drive pin 67 is not coaxial with wheel 60. Thus, when motor 58 turns wheel 60, drive pin 61 traces a circular path. In the view shown in FIG. 3A, linear slot 67 extends normal to the page, that is into and out of the page. Linear slot 67 has a width approximately the same as and preferably slightly larger than the diameter of drive pin 61 such that drive pin 61 can move within linear slot 67 without binding. FIG. 3B illustrates that linear slot can extend the entire width or diameter of drive rod 62 and that drive pin 61 can travel along the length of linear slot 67.

FIG. 3C illustrates the drive pin 61 in operation, showing drive pin 61 turning a full 3600, with the first subfigure begin at a relative 0° starting position, the second subfigure showing a 90° travel from the first subfigure, the third subfigure showing a 90° travel from the second subfigure, the fourth subfigure showing a 90° travel from the third subfigure, and the first subfigure also showing a 90° travel from the fourth subfigure. Motor 58 turns wheel 60 causing drive pin 61 to trace a circular path, as indicated by the arced arrows proximal to drive pin 61. As shown in the first subfigure, drive pin 61 is moving in a direction with a Y-axis vector and contacts the side wall of linear slot 67, thus forcing cylindrical extension 40 (and as a result stem 14) upwards (relative to the page). As shown in the second subfigure, drive pin 61 is moving mostly in a direction with an X-axis vector, which does not impart movement to cylindrical extension 40 and thus does not move cylindrical extension 40 or stem 14 in the X-axis direction. Thus, as drive pin 61 moves in the X-axis direction along linear slot 67, no X-axis movement is imparted to cylindrical extension 40 or stem 14. As shown in the third subfigure, drive pin 61 is moving in a direction with a Y-axis vector and contacts the side wall of linear slot 67, thus forcing cylindrical extension 40 (and as a result stem 14) downwards (relative to the page). As shown in the fourth subfigure, drive pin 61 is moving mostly in a direction with an X-axis vector, which does not impart movement to cylindrical extension 40 and thus does not move cylindrical extension 40 or stem 14 in the X-axis direction. Again, as drive pin 61 moves in the X-axis direction along linear slot 67, no X-axis movement is imparted to cylindrical extension 40 or stem 14. Thus, as drive pin 61 turns, cylindrical extension 40 and thus stem 14 only move back and forth in the Y-axis direction, giving the sweeping motion to stem 14 and head 16 as stem 14 pivots about pivot pin 64. Diameter centerline CL of wheel 60 illustrates that during the rotational movement, wheel 60 remains in the same relative position while cylindrical extension 40 moves relative to wheel 60.

FIG. 4 illustrates various static positions for head 16 to be placed in via wire 80 as shown in FIG. 2C in order to aid the user in brushing. For example, it may be more convenient for the user to have head 16 angled towards the mouth or away from the mouth.

FIGS. 5A-5D illustrate that toothbrush 10 can include a plurality of detachable stems 14 with heads 16 of different sizes and shapes containing rows with tufts of bristles 18 variously arranged. In particular, FIG. 5A shows a generally rectangular shaped head wherein the tip to of head 16 is more narrow than the base of head 16 in the shape of a truncated triangle, FIG. 5B shows a large oval-shaped head, FIG. 5C shows a small oval-shaped head, and FIG. 5D shows a generally rectangular head. In the preferred embodiment, at least one of the head designs shown has soft bristles while at least one of the head designs has hard bristles which are especially effective for occlusals. When the features of the multiple head arrangements are combined with the flexible positioning capabilities of stem 14, one obtains a toothbrush 10 which can be adapted to utilize practically all of the head designs and stem angles that are recommended and used by the various toothbrush manufacturers.

FIG. 5E illustrates a bottom view of a preferred configuration of cylindrical extension 40 of stem 14 showing a preferred orientation of the various holes 46 into which protrusion 48 fits. It is preferred that φ be 45 degrees or less in order to obtain a proper orientation to practice the Bass technique as discussed above, though any number and orientation of holes 46 can be included.

Use of toothbrush 10 of the present invention by a right-handed person will now be described. First, in the embodiment with detachable stems 14, stem 14 having the desired head 16 is attached to the top of handle 12. Next stem 14 and/or head 16 is/are flexed (bent) and/or shaped and formed to the preferred lateral displacement relative to flat portion 22 of handle 12, if desired. Toothbrush 10 is then moved into a horizontal position in front of the mouth with head 16 on the left (bristles 18 facing the mouth) and handle 12 on the right (flat portion 22 facing mouth). The thumb should be positioned on flat portion 22 of handle 12 with the fingers curled around stem 14. Some of the fingertips may also be positioned on flat portion 22 of handle 12.

To brush the outside surface of the teeth in the upper left quadrant of the mouth, stem 14 and head 16 are rotated 45° upward (FIG. 1C). Toothbrush 10 is now in position to implement the Bass brushing technique by applying toothpaste to bristles 18, turning “on” toothbrush 10, placing bristles 18 of toothbrush 10 against the teeth and gums and using short back and forth strokes as described above. The combination of the short back and forth (lateral) strokes by the user and the up and down movement of head 16 due to the movement caused by motor 58 then cleans the teeth. As discussed above, it is also anticipated that electric motor can cause head 16 to be moved laterally (with respect to the user's teeth) in addition to the movement described above. In such an embodiment bristles 18 are moved both vertically and horizontally to clean the teeth.

Stem 14 is in position to brush lower left outside and lower right inside teeth. Flip toothbrush 10 over and clean the upper right outside and upper left inside teeth. Rotate stem 14 so that stem is 45° downward (FIG. 1B). Brush lower right outside and lower left inside teeth. Flip toothbrush 10 over and clean upper left outside and upper right inside teeth. Return stem 14 to the center position (FIG. 1A) and bend head 16 slightly forward (concave) to brush inside upper and lower front teeth, all chewing surfaces, and behind the back molars.

These instructions only require very simple (but exact) stem rotations throughout the entire brushing procedure. Because handle 12 can be “double-sided,” it enables the user to maintain the same grip throughout the entire mouth. This drastically increases manual dexterity (i.e., effectiveness) and enables the user to be consistent in brushing. The double-sided handle also enables the user to brush all areas of the mouth in the usual or preferred order that aids in compliance and simplicity while using the same natural grip. Furthermore, the double-sided design and three simple rotations not only enables the user to brush normally and naturally but, in addition, drastically increases manual dexterity and comfort. The 45° stem rotation drastically augments a user's understanding of and implementation of the Bass Technique. The instructions for use are simple, requiring only three rotations, and are designed to follow the normal patterns and brushing habits of the average user that is important to implementation of and compliance with the Bass Technique.

With all toothbrushes (including electric toothbrushes) one has to flip toothbrush 10 over to go from brushing the upper teeth to brushing the lower teeth, which, like toothbrush 10 of the present invention, is normal and natural to all users. However, in order to achieve a 45° angle relative to all dental surfaces, one must constantly change his or her grip (losing dexterity) or, constantly torque the handle and one's hand and wrist to very unnatural grips and positions. Hence, effective brushing using the Bass Technique in all areas of the mouth has been virtually impossible prior to the present invention.

In accordance with another feature of the present invention, FIGS. 6A-6D show an elongated toothbrush head 16 which is bendable and shapeable so that the user of toothbrush 10 may adjust the shape or curvature of head 16 to conform to the contour of specific dental surfaces. For example, head 16 may be bent forward as shown in FIG. 6C or backwards as shown in FIG. 6D to impart a concave or convex curvature to bristles 18 mounted in head 16 so that bristles 18 more efficiently interact with variations in the concave and convex shapes of an individual tooth or the general concave or convex arrangement of one's teeth in the mouth. For example, one could use the concave arrangement to brush the outside surfaces of the teeth and the convex arrangement to brush the inside surfaces of the teeth. To facilitate the flexibility of head 16 while at the same time maintaining sufficient structural integrity to withstand the forces applied to head 16 during brushing, head 16 may be formed of rubber with a flexible wire 90 and/or hinges 92 which, along with a flexible substrate 94 to which the tufts of bristles 18 are anchored, are imbedded within the rubber head. As shown in FIG. 6A, head 16 preferably has an elongated oval design that enables the user of toothbrush 10 to effectively brush larger areas of the mouth more quickly and effectively. Head 16 also can be longer than the standard toothbrush and bendable so as to conform to the curvature of one's mouth, dramatically increasing effectiveness in brushing.

The invention can be marketed in a kit form with a single handle 12 and a plurality of replaceable stems 14. The various stems 14 can thus be replacements, specific task oriented shapes/stiffness, or individually assigned to different members of a family. Color distinction and firmness are thus often characteristics of the different heads in a kit. Although handle 12 is discussed as preferably battery powered, of course, the invention also includes other well-known power supplies such as corded for outlet connection or rechargeable batteries and an associated brush holder/charger (not shown).

The foregoing detailed description of the preferred embodiments and the appended figures have been presented only for illustrative and descriptive purposes. They are not intended to be exhaustive and are not intended to limit the scope and spirit of the invention. The embodiments were selected and described to best explain the principles of the invention and its practical applications. One skilled in the art will recognize that many variations can be made to the invention disclosed in this specification without departing from the scope and spirit of the invention.

What is claimed is:

1. An electric toothbrush for brushing teeth and gums, said toothbrush comprising:
a generally cylindrical handle having a longitudinal axis and a generally hollow interior;
a stem attached to said handle;
a head connected to said stem and having a front portion with a plurality of tufts of bristles anchored to said head; and
a motor housed in the hollow interior of said handle,
wherein said stem is operatively moved by said motor such that said stem pivots with respect to the longitudinal axis of the cylindrical handle by a predefined angle Θ within a plane to impart a measured up and down sweeping motion to the head relative to the teeth and gums being brushed.

2. The toothbrush as claimed in claim 1, wherein said stem is rotatable within said handle and may be selectively positioned at one of a plurality of locations about the longitudinal axis of said handle.

3. The toothbrush as claimed in claim 2, wherein said front portion is arranged so that in one of said plurality of locations of rotation the bristles of the head are at about a forty-five degree angle relative to a centerline of said handle, whereby the Bass technique of brushing teeth and gums can be practiced without twisting of the toothbrush handle by the user by moving the toothbrush against the surface of the teeth and gums in a conventional manner.

4. The toothbrush as claimed in claim 1, wherein said stem is rotatable within said handle and may be selectively positioned in three different positions, wherein in a first position the bristles of the head are at about a zero degree angle relative to a centerline of said handle, in a second position the bristles of the head are at about a positive forty-five degree angle relative to a centerline of said handle, and in a third position the bristles of the head are at about a negative forty-five degree angle relative to a centerline of said handle.

5. The toothbrush as claimed in claim 1, wherein said stem is rotatable within said handle and may be selectively positioned in two different positions, wherein in a first position the bristles of the head are at about a positive forty-five degree angle relative to a centerline of said handle, and in a second position the bristles of the head are at about a negative forty-five degree angle relative to a centerline of said handle.

6. The toothbrush as claimed in claim 1, wherein the head is bendable and will remain in a bent position during normal brushing of teeth.

7. The toothbrush as claimed in claim 6, further comprising a wire embedded within said head to permit modification of the curvature of the head relative to the surface of the teeth when brushing.

8. The toothbrush as claimed in claim 1, wherein said stem may be selectively bent relative to the longitudinal axis of said handle.

9. The toothbrush as claimed in claim 1, wherein said stem pivots in a plane that includes the longitudinal axis of the handle.

10. The toothbrush as claimed in claim 1, wherein said bristles are stationary with respect to said stem.

11. The toothbrush as claimed in claim 1 wherein, said angle Θ is up to about 10 degrees.

12. The toothbrush as claimed in claim 1 wherein, said angle Θ is up to about 6 degrees.

13. The toothbrush as claimed in claim 1, wherein said generally cylindrical handle includes a flat portion for supporting a thumb and fingertips.

14. The toothbrush as claimed in claim 1, further comprising a drive mechanism operatively connecting said motor with said stem and a pivot pin about which said stem pivots,
said drive mechanism including a drive wheel, a drive pin, and a drive rod,
said drive wheel being is operatively connected to and powered by said motor on a first side of said drive wheel, and to said drive pin, which is attached to in an offset manner to said drive wheel on a second side of said drive wheel opposite the first side,
said drive rod having an axis and being operatively connected to drive pin via a linear slot formed in a bottom end of said drive rod,
said pivot pin extending through and normal to the axis of said drive rod and pivotally supporting said drive rod within the hollow interior of said handle,
wherein activation of said motor causes said drive wheel to spin, which causes said drive pin to trace a circular path in an X-Y plane and as said drive pin moves in the X-axis direction component, said drive pin slides within said linear slot imparting no X-axis direction motion to said drive rod, and as said drive pin moves in the Y-axis direction component, said drive pin contacts a side wall of said linear slot causing said drive rod to pivot about said pivot pin causing said drive rod to pivot about said pivot pin such that said stem also moves, pivoting about said pivot pin in a side-to-side motion in a plane normal to the axis of said pivot pin, imparting a planar two-dimensional sweeping motion to said stem and said head.

15. An electric toothbrush for brushing teeth and gums, said toothbrush comprising:
a generally cylindrical handle having a longitudinal axis and a generally hollow interior;
a stem attached to said handle;
a head connected to said stem and having a front portion with a plurality of tufts of bristles anchored to said head; and
a motor housed in the hollow interior of said handle, and
a drive mechanism operatively connecting said motor with said stem and a pivot pin about which said stem pivots,
said drive mechanism including a drive wheel, a drive pin, and a drive rod,
said drive wheel being is operatively connected to and powered by said motor on a first side of said drive wheel, and to said drive pin, which is attached to in an offset manner to said drive wheel on a second side of said drive wheel opposite the first side,
said drive rod having an axis and being operatively connected to drive pin via a linear slot formed in a bottom end of said drive rod,
said pivot pin extending through and normal to the axis of said drive rod and pivotally supporting said drive rod within the hollow interior of said handle,
wherein activation of said motor causes said drive wheel to spin, which causes said drive pin to trace a circular path in an X-Y plane and as said drive pin moves in the X-axis direction component, said drive pin slides within said linear slot imparting no X-axis direction motion to said drive rod, and as said drive pin moves in the Y-axis direction component, said drive pin contacts a side wall of said linear slot causing said drive rod to pivot about said pivot pin causing said drive rod to pivot about said pivot pin such that said stem also moves, pivoting about said pivot pin in a side-to-side motion in a plane normal to the axis of said pivot pin, imparting a planar two-dimensional sweeping motion to said stem and said head.

16. The toothbrush as claimed in claim 15, wherein said stem is operatively moved by said motor such that said stem pivots with respect to the longitudinal axis of the cylindrical handle by a predefined angle Θ within a plane generally normal to the plurality of tufts of bristles to impart a measured up and down sweeping motion to the head relative to the teeth and gums being brushed.

17. The toothbrush as claimed in claim 16, wherein said stem is rotatable within said handle and may be selectively positioned in three different positions, wherein in a first position the bristles of the head are at about a zero degree angle relative to a centerline of said handle, in a second position the bristles of the head are at about a positive forty-five degree angle relative to a centerline of said handle, and in a third position the bristles of the head are at about a negative forty-five degree angle relative to a centerline of said handle.

18. The toothbrush as claimed in claim 16, wherein said stem is rotatable within said handle and may be selectively positioned in two different positions, wherein in a first position the bristles of the head are at about a positive forty-five degree angle relative to a centerline of said handle, and in a second position the bristles of the head are at about a negative forty-five degree angle relative to a centerline of said handle.

19. The toothbrush as claimed in claim 16 wherein, said angle Θ is up to about 10 degrees.

20. The toothbrush as claimed in claim 19, wherein the head is bendable and will remain in a bent position during normal brushing of teeth.
